(19) United States
(12) Patent Application Publication
(10) Pub. No.: US 2024/0172302 A1
(43) Pub. Date: May 23, 2024

(54) MITIGATING LOSS OF CONNECTIVITY DUE TO LINE-OF-SIGHT BLOCKAGES

(71) Applicant: INTERNATIONAL BUSINESS MACHINES CORPORATION, ARMONK, NY (US)

(72) Inventor: Sarbajit K. Rakshit, Kolkata (IN)

(21) Appl. No.: 18/057,739

(22) Filed: Nov. 21, 2022

(51) Int. Cl. H04W 76/14; H04W 4/44; H04W 4/46

(52) U.S. Cl. CPC H04W 76/14; H04W 4/44; H04W 4/46

(57) ABSTRACT

An embodiment for mitigating loss of connectivity in autonomous vehicles due to line-of-sight blockages is provided. The embodiment may automatically identify one or more impact zones and one or more non-impact zones located within a selected region. The embodiment may automatically identify a predicted line-of-sight blockage for a target vehicle entering the one or more impact zones. The embodiment may then automatically identify a secondary vehicle positioned to provide backup connectivity to the target vehicle. The embodiment automatically establish connectivity between the target vehicle and the secondary vehicle before the target vehicle reaches a position corresponding to the predicted line-of-sight blockage.

### BACKGROUND

The present application relates generally to wireless communication, and more particularly, to a method of mitigating loss of connectivity in autonomous vehicles due to line-of-sight blockages.

Satellites are often relied upon to provide a universal reliable connection that is both high speed and low latency for a variety of technologies. Vehicles have become more advanced and reliant upon technology and will increasingly depend upon consistent and reliable connections to maintain various functionalities and overall safety. As autonomous vehicle technology continues to develop, there is speculation that fleets of autonomous vehicles may be created to serve public transportation objectives. The ability of satellite technology to broadcast vital information or commands to vehicles en masse provides a significant advantage over cellular technologies. Thus, ensuring seamless connectivity between satellites and autonomous vehicles will become increasingly important.

### SUMMARY

According to one embodiment, a method, computer system, and computer program product for mitigating loss of connectivity in autonomous vehicles due to line-of-sight blockage is provided. The embodiment may include automatically identifying one or more impact zones and one or more non-impact zones located within a selected region. The embodiment may also include automatically identifying a predicted line-of-sight blockage for a target vehicle entering the one or more impact zones. The embodiment may further include automatically identifying a secondary vehicle positioned to provide backup connectivity to the target vehicle. The embodiment may also include automatically establishing connectivity between the target vehicle and the secondary vehicle before the target vehicle reaches a position corresponding to the predicted line-of-sight blockage.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for a process of mitigating loss of connectivity in autonomous vehicles due to line-of-sight blockages according to at least one embodiment;

FIG. 3 depicts a block diagram including components and an exemplary framework for an illustrative system configured to mitigate loss of connectivity in autonomous vehicles due to line-of-sight blockages according to at least one embodiment; and

FIG. 4 depicts an illustrative framework for predicting impact zones according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to wireless communication, and more particularly, to a method of mitigating loss of connectivity in autonomous vehicles due to line-of-sight blockages. The following described exemplary embodiments provide a system, method, and program product to, among other things, automatically identify one or more impact zones and one or more non-impact zones located within a selected region, automatically identify a predicted line-of-sight blockage for a target vehicle entering the one or more impact zones, and then automatically identify a secondary vehicle positioned to provide backup connectivity to the target vehicle, and thereafter, automatically establish connectivity between the target vehicle and the secondary vehicle before the target vehicle reaches a position corresponding to the predicted line-of-sight blockage. Therefore, the presently described embodiments have the capacity to improve mitigation of loss of connectivity in autonomous vehicles due to line-of-sight blockages by identifying impact zones to anticipate predicted line-of-sight blockages, and then proactively establishing backup connections for the target vehicles approaching the predicted line-of-sight blockage by utilizing secondary vehicles that are in nearby non-impact zones to ensure seamless connectivity is maintained.

As previously described, satellites are often relied upon to provide a universal reliable connection that is both high speed and low latency for a variety of technologies. Vehicles have become more advanced and reliant upon technology and will increasingly depend upon consistent and reliable connections to maintain various functionalities and overall safety. As autonomous vehicle technology continues to develop, there is speculation that fleets of autonomous vehicles may be created to serve public transportation objectives. The ability of satellite technology to broadcast vital information or commands to vehicles en mass provides a significant advantage over cellular technologies. Thus, ensuring seamless connectivity between satellites and autonomous vehicles will become increasingly important.

One significant challenge for maintaining seamless satellite connectivity to autonomous vehicles is line-of-sight blockages. For example, trees and buildings will commonly obstruct the line-of-sight between an autonomous vehicle and a satellite to which it is connected. Outages or interruptions in connectivity due to these line-of-sight blockages may temporarily limit autonomous vehicle safety and functionality, and, in the future, may even create regulatory risk for autonomous vehicle manufacturers and other interested parties.

Accordingly, a method, computer system, and computer program product for improved methods of mitigating loss of connectivity in autonomous vehicles due to line-of-sight blockages would be advantageous. The method, system, and computer program product may automatically identify one or more impact zones and one or more non-impact zones located within a selected region. The method, system, computer program product may automatically identify a predicted line-of-sight blockage for a target vehicle entering the one or more impact zones. The method, system, computer program product may then automatically identify a secondary vehicle positioned to provide backup connectivity to the target vehicle. The method, system, computer program product may then automatically establish connectivity between the target vehicle and the secondary vehicle before the target vehicle reaches a position corresponding to the predicted line-of-sight blockage. In turn, the method, system, computer program product has provided improved methods for mitigating loss of connectivity in autonomous vehicles due to line-of-sight blockages by identifying impact zones to anticipate predicted line-of-sight blockages, and then proactively establishing backup connections for the target vehicles approaching the predicted line-of-sight blockage by utilizing secondary vehicles that are in nearby non-impact zones to ensure seamless connectivity is maintained.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

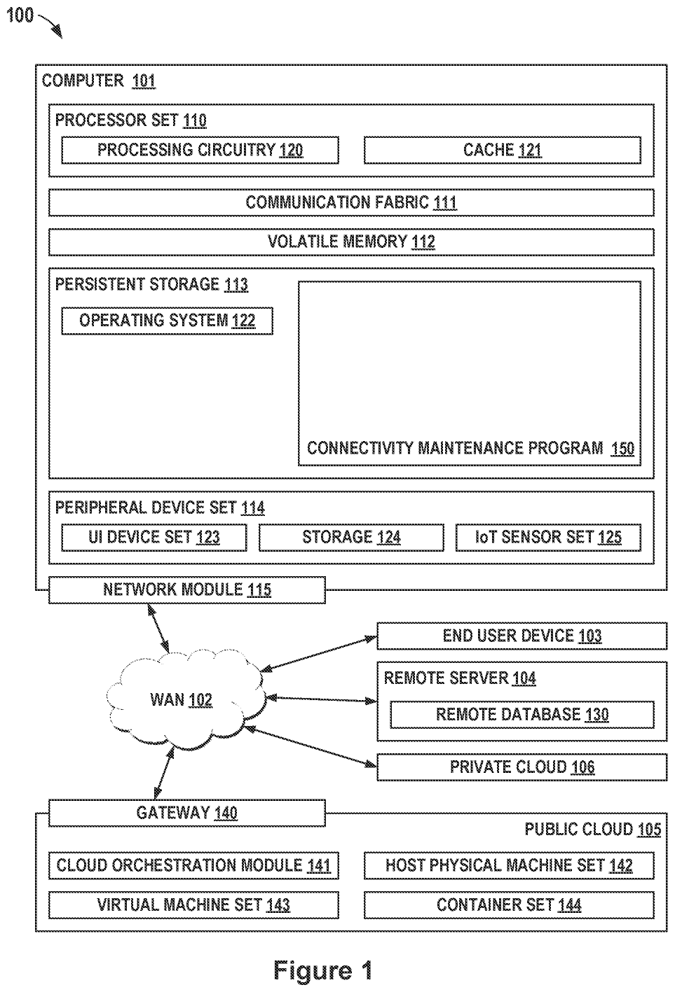

Referring now to FIG. 1, computing environment 100 contains an example of an environment for the execution of at least some of the computer code involved in performing the inventive methods, such as connectivity maintenance program/code 150. In addition to connectivity maintenance code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and connectivity maintenance code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in connectivity maintenance code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in connectivity maintenance code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the connectivity maintenance program 150 may be a program capable of automatically identifying one or more impact zones and one or more non-impact zones located within a selected region. Connectivity maintenance program 150 may then automatically identify a predicted line-of-sight blockage for a target vehicle entering the one or more impact zones. Next, connectivity maintenance program 150 may automatically identify a secondary vehicle positioned to provide backup connectivity to the target vehicle. Connectivity maintenance program 150 may then automatically establish connectivity between the target vehicle and the secondary vehicle before the target vehicle reaches a position corresponding to the predicted line-of-sight blockage. In turn, connectivity maintenance program 150 has provided improved methods for mitigating loss of connectivity in autonomous vehicles due to line-of-sight blockages by identifying impact zones to anticipate predicted line-of-sight blockages, and then proactively establishing backup connections for the target vehicles approaching the predicted line-of-sight blockage by utilizing secondary vehicles that are in nearby non-impact zones to ensure seamless connectivity is maintained.

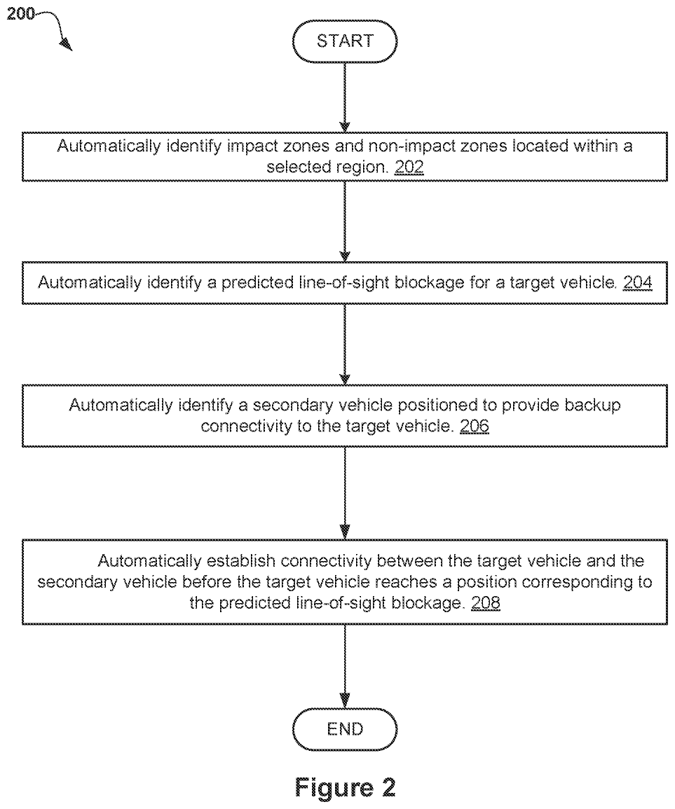

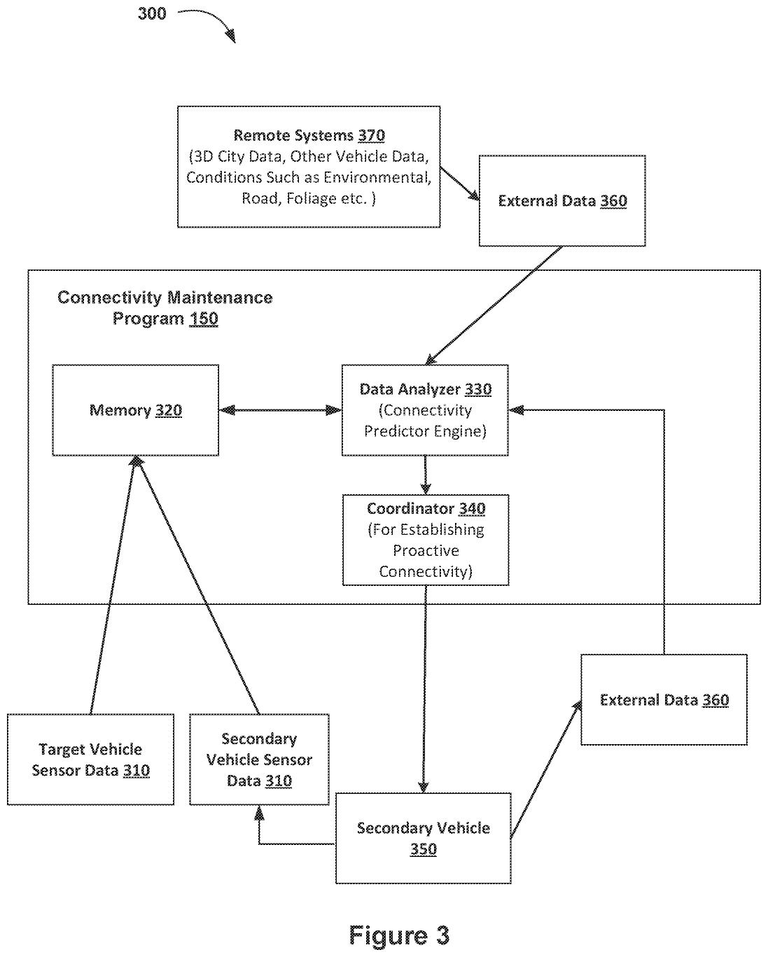

Referring now to FIG. 2, an operational flowchart for a process 200 of mitigating loss of connectivity in autonomous vehicles due to line-of-sight blockages according to at least one embodiment is provided. FIG. 3 depicts a block diagram including components and a framework according to at least one embodiment and will be referenced below throughout the description of process 200.

At 202, connectivity maintenance program 150 may automatically identify one or more impact zones and one or more non-impact zones located within a selected region. In the context of this disclosure, impact zones include any regions along a target vehicle's route which include, or are near, a predicted line-of-sight obstruction that may result in an interruption in connectivity for the target vehicle. Non-impact zones are regions along a route in which no line-of-sight blockages or interruptions in connectivity are predicted.

Referring now to framework 300 shown in FIG. 3, to identify impact zones and non-impact zones, connectivity maintenance program 150 utilizes a data analyzer 330 to interpret received external data 360 to predict line-of-sight blockages and identify the corresponding impact zones on a given target vehicle's route. External data 360 may include a variety of useful datapoints, including 3D city data (or town, province, county, etc), data concerning other vehicles, conditional data (e.g., environmental, road, foliage) etc. External data 360 may be gathered and retrieved from remote systems 370 which include any suitable and known remote systems for gathering external data 360. Remote systems 370 may include any cloud-based services or data gathering solutions. For example, connectivity maintenance program 150 may include remote systems configured to retrieve and continuously monitor Global Position System (GPS) data, Global navigation satellite system (GNSS) data, Forecast Assured Navigation (FAN) data, satellite data etc. These modern tools provide surveyed global 3D maps and digital city maps which may show dimensions of buildings, terrain, vegetation, road width, and other obstacles. External data 360 may further include ray-trace data between selected points on the map to determine if satellites are blocked or obscured by buildings or objects in the stored 3D maps. In other words, connectivity maintenance program 150 may automatically use the compiled 3D city data to identify the impact zones based upon the positions of one or more of detected buildings, objects, or foliage in relation to one or more relevant satellites by determining in which regions the relevant satellites may be obscured. External data 360 may further include data related to the route being taken by the target vehicle and any relevant secondary vehicles including road outage conditions, traffic conditions, environmental or weather conditions, foliage, and any known outages or connectivity issues along the route.

Once data analyzer 330 of connectivity maintenance program 150 receives external data 360, the processed data may be stored in memory 320. Connectivity maintenance program 150 may gather and store data from multiple vehicles to create a historical dataset to improve future predictions of line-of-sight blockages and outages.

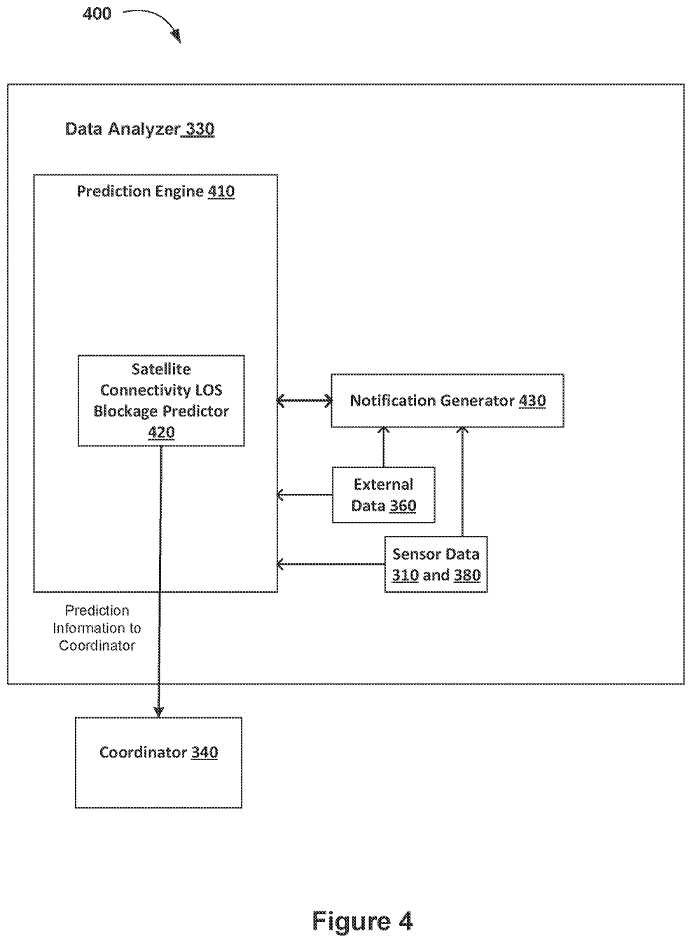

FIG. 4 depicts a framework 400 for predicting impact zones according to at least one embodiment. As shown in FIG. 4, data analyzer 330 of connectivity maintenance program 150 includes a prediction engine 410 configured to receive external data 360 and sensor data 310 from autonomous vehicles. Sensor data 310 may be obtained from a target vehicle or a secondary vehicle and may include, for example, direction of travel of the vehicle, vehicle speed, current location of the vehicle, time of day, historical vehicle information (including historical outage or downtime information), vehicle dimensions, etc. Connectivity maintenance program 150 can accordingly track the real-time position and status of target vehicles and secondary vehicles. Prediction engine 410 of connectivity maintenance program 150 may then utilize the above-described data to identify zones of impact in which autonomous vehicles may experience interruptions to connectivity due to line-of-sight blockage with the satellite. For example, if connectivity maintenance program 150 is being employed to monitor the connectivity for an autonomous target vehicle A traveling on a route X, data analyzer 330 of connectivity maintenance program 150 will automatically utilize external data 360 and target vehicle sensor data 310 to identify impact zones along the route where buildings, foliage, or some other obstructions or line-of-sight blockages may result in an interruption in connectivity. Connectivity maintenance program 150 will also identify adjacent and nearby non-impact zones in which secondary vehicles having a reliable connectivity status may be positioned.

In embodiments, connectivity maintenance program 150 may further include a notification generator 430 which may be configured to generate notifications corresponding to predictions or determinations made by data analyzer 330. The generated notifications may then be displayed to a user or driver via a convenient display. For example, a notification may be generated warning of a potential outage or indicating when a historical region of outage or interruptions in connectivity is upcoming. In other embodiments notification generator 430 may output suggestions to a driver related to the predicted line-of-sight blockages. For example, notification generator 430 may output a recommendation to increase speed during predicted line-of-sight blockages.

Next, at 204, once the impact zones have been identified, connectivity maintenance program 150 may automatically identify a predicted line-of-sight blockage for a target vehicle entering the one or more impact zones. As discussed above, connectivity maintenance program 150 has at this stage processed both external data related to the surrounding buildings and environment and information about the target vehicle and its route, including historical information. Using this information, connectivity maintenance program 150 may predict line-of-sight blockages that are likely to cause interruptions in connectivity for the target vehicle and may also determine (and store) the expected duration of line-of-sight obstruction, the probability of an outage occurring, and the degree of expected obstruction. For example, for Target vehicle A discussed above, connectivity maintenance program 150 may identify an upcoming line-of-sight blockage in an exemplary Impact Zone 1 in which target vehicle A has a high likelihood of experiencing an interruption in connectivity. Connectivity maintenance program 150 may further determine, using the gathered data, when the target vehicle is expected to arrive at the line-of-sight blockage and the expected duration of the interruption to connectivity. For example, connectivity maintenance program 150 may predict a line-of-sight blockage that is expected to last for approximately 20 seconds during a 0.2-mile stretch of road within impact zone 1.

At 206, connectivity maintenance program 150 may automatically identify a secondary vehicle positioned to provide backup connectivity to the target vehicle. Returning to the example above, if connectivity maintenance program 150, at 204, determines that target vehicle A is approaching impact zone 1 and identifies a high likelihood of a line-of-sight blockage causing an interruption in connectivity for approximately 20 seconds during a 0.2-mile stretch of road within impact zone 1, connectivity maintenance program 150 may then identify a secondary vehicle positioned to provide backup connectivity to the target vehicle. As shown in FIG. 3, data analyzer 330 may receive secondary vehicle sensor data as well as corresponding external data directly from the secondary vehicle or from memory 320. Analyzer 330 may then identify secondary vehicles that will be positioned within non-impact zones for the duration of the predicted interruption to be experienced by the target vehicle. This positioning has a higher likelihood of ensuring that the secondary vehicle can provide a reliable backup connection for the target vehicle. Connectivity maintenance program 150 will prioritize secondary vehicles that are predicted to be closest in proximity to the target vehicle (while remaining in a non-impact zone) for the duration of the line-of-sight blockage. At this step, connectivity maintenance program 150 may further identify, based on the received external data and sensor data of the selected secondary vehicle, the position at which the secondary vehicle will be when the target vehicle is expected to experience the line-of-sight blockage.

At 208, connectivity maintenance program 150 may automatically establish connectivity between the target vehicle and the secondary vehicle before the target vehicle reaches a position corresponding to the predicted line-of-sight blockage. At this step, knowing the expected position of the target vehicle that is about to experience the line-of-sight blockage, and the expected position of the secondary vehicle during this predicted line-of-sight blockage, coordinator 340 of connectivity maintenance program 150 communicate with the secondary vehicle to prompt the establishment of a backup connection, allowing the target vehicle to utilize the secondary vehicle's connection to ensure there is no interruption in the connectivity of the target vehicle with any satellites during the predicted line-of-sight blockage. In other embodiments, coordinator 340 of connectivity maintenance program 150 may be configured to communicate with appropriate connectivity infrastructure (or static secondary vehicles for the same purpose) installed by governments or vehicle manufacturers r to create a vehicle-to-infrastructure (V2I) network to allow the target vehicle to establish a backup connection to ensure seamless connectivity during a predicted line-of-sight blockage.

It may be appreciated that connectivity maintenance program 150 ensures that a target vehicle maintains seamless connectivity to a satellite connection, even in the presence of line-of-sight blockages, by leveraging the connections of nearby secondary vehicles positioned in nearby non-impact regions by monitoring and utilizing real-time vehicle sensor data and external data including 3D city data to establish backup connections at the appropriate times. This ensures that a satellite connection is always maintained, especially within impact zones where switching to another satellite may not be a viable option due to high amounts of obstructions and line-of-sight blockages. Connectivity maintenance program 150 also avoids the need to switch a vehicle to cellular or another alternative network type to maintain connectivity. Accordingly, connectivity maintenance program 150 has provided an improved method of mitigating loss of connectivity in autonomous vehicles due to line-of-sight blockages

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of mitigating loss of connectivity in autonomous vehicles due to line-of-sight blockage, the method comprising:
automatically identifying one or more impact zones and one or more non-impact zones located within a selected region;
automatically identifying a predicted line-of-sight blockage for a target vehicle entering the one or more impact zones;
automatically identifying a secondary vehicle positioned to provide backup connectivity to the target vehicle; and
automatically establishing connectivity between the target vehicle and the secondary vehicle before the target vehicle reaches a position corresponding to the predicted line-of-sight blockage.

2. The computer-based method of claim 1, wherein automatically identifying one or more impact zones and one or more non-impact zones located within a selected region further comprises:
automatically compiling 3-dimensional (3D) city data comprising one or more of global position system data, global navigation satellite system data, forecast assured navigation data, and ray-trace data.

3. The computer-based method of claim 2 further comprising:
automatically identifying the impact zones using the compiled 3D city data including positions of one or more of detected buildings, objects, or foliage in relation to one or more satellites.

4. The computer-based method of claim 1, wherein automatically identifying the predicted line-of-sight blockage for the target vehicle entering the one or more impact zones further comprises:
automatically utilizing sensor data and external data from the target vehicle to determine an expected location of the target vehicle and an expected duration corresponding to the identified predicted line-of-sight-blockage.

5. The computer-based method of claim 1, wherein automatically identifying the secondary vehicle positioned to provide the backup connectivity to the target vehicle further comprises:
automatically determining, based on received secondary vehicle external data and secondary vehicle sensor data, a future position of the secondary vehicle that corresponds to the predicted line-of-sight blockage of the target vehicle.

6. The computer-based method of claim 1, wherein establishing the backup connectivity for the target vehicle before the target vehicle reaches the position corresponding to the predicted line-of-sight blockage further comprises:
automatically connecting to pre-installed connectivity infrastructure using a vehicle-to-infrastructure (V2I) connection.

7. The computer-based method of claim 1, wherein the identified secondary vehicle is expected to be positioned within the identified non-impact zones during a time corresponding to the predicted line-of-sight blockage for the target vehicle.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically identifying one or more impact zones and one or more non-impact zones located within a selected region;
automatically identifying a predicted line-of-sight blockage for a target vehicle entering the one or more impact zones;
automatically identifying a secondary vehicle positioned to provide backup connectivity to the target vehicle; and
automatically establishing connectivity between the target vehicle and the secondary vehicle before the target vehicle reaches a position corresponding to the predicted line-of-sight blockage.

9. The computer system of claim 8, wherein automatically identifying one or more impact zones and one or more non-impact zones located within a selected region further comprises:
automatically compiling 3-dimensional (3D) city data comprising one or more of global position system data, global navigation satellite system data, forecast assured navigation data, and ray-trace data.

10. The computer system of claim 9, automatically identifying the impact zones using the compiled 3D city data including positions of one or more of detected buildings, objects, or foliage in relation to one or more satellites.

11. The computer system of claim 8, wherein automatically identifying the predicted line-of-sight blockage for the target vehicle entering the one or more impact zones further comprises:
automatically utilizing sensor data and external data from the target vehicle to determine an expected location of the target vehicle and an expected duration corresponding to the identified predicted line-of-sight-blockage.

12. The computer system of claim 8, wherein automatically identifying the secondary vehicle positioned to provide the backup connectivity to the target vehicle further comprises:
automatically determining, based on received secondary vehicle external data and secondary vehicle sensor data, a future position of the secondary vehicle that corresponds to the predicted line-of-sight blockage of the target vehicle.

13. The computer system of claim 8, wherein establishing the backup connectivity for the target vehicle before the target vehicle reaches the position corresponding to the predicted line-of-sight blockage further comprises:
automatically connecting to pre-installed connectivity infrastructure using a vehicle-to-infrastructure (V2I) connection.

14. The computer system of claim 8, wherein the identified secondary vehicle is expected to be positioned within the identified non-impact zones during a time corresponding to the predicted line-of-sight blockage for the target vehicle.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically identifying one or more impact zones and one or more non-impact zones located within a selected region;
automatically identifying a predicted line-of-sight blockage for a target vehicle entering the one or more impact zones;
automatically identifying a secondary vehicle positioned to provide backup connectivity to the target vehicle; and
automatically establishing connectivity between the target vehicle and the secondary vehicle before the target vehicle reaches a position corresponding to the predicted line-of-sight blockage.

16. The computer program product of claim 15, wherein automatically identifying one or more impact zones and one or more non-impact zones located within a selected region further comprises:
automatically compiling 3-dimensional (3D) city data comprising one or more of global position system data, global navigation satellite system data, forecast assured navigation data, and ray-trace data.

17. The computer program product of claim 16, automatically identifying the impact zones using the compiled 3D city data including positions of one or more of detected buildings, objects, or foliage in relation to one or more satellites.

18. The computer program product of claim 15, wherein automatically identifying the predicted line-of-sight blockage for the target vehicle entering the one or more impact zones further comprises:
automatically utilizing sensor data and external data from the target vehicle to determine an expected location of the target vehicle and an expected duration corresponding to the identified predicted line-of-sight-blockage.

19. The computer program product of claim 15, wherein automatically identifying the secondary vehicle positioned to provide the backup connectivity to the target vehicle further comprises:
automatically determining, based on received secondary vehicle external data and secondary vehicle sensor data, a future position of the secondary vehicle that corresponds to the predicted line-of-sight blockage of the target vehicle.

20. The computer program product of claim 15, wherein establishing the backup connectivity for the target vehicle before the target vehicle reaches the position corresponding to the predicted line-of-sight blockage further comprises:
automatically connecting to pre-installed connectivity infrastructure using a vehicle-to-infrastructure (V2I) connection.
